(19) United States
(12) Patent Application Publication
(10) Pub. No.: US 2015/0022774 A1
(43) Pub. Date: Jan. 22, 2015

(54) SNAP-FIT TYPE EYEGLASSES

(71) Applicant: LIN YUN CHEN, TAINAN CITY (TW)

(72) Inventor: LIN YUN CHEN, TAINAN CITY (TW)

(21) Appl. No.: 13/942,889

(22) Filed: Jul. 16, 2013

(51) Int. Cl. G02C 9/04

(52) U.S. Cl. CPC G02C 9/04
USPC 351/57

(57) ABSTRACT

Snap-fit type eyeglasses include a frame having a bottom edge. The bottom edge includes a groove having a downwardly facing opening. A stop is provided on each of two ends of the groove. A temple is pivotably mounted to each of two ends of the frame. A snapping member is pivotably mounted to each end of the frame and has a snapping hook on an end thereof. A lens unit includes two lenses integrally formed with each other as a single, monolithic piece. The lens unit includes two ends each having a slot. The snapping hook of each snapping member is releasably engaged in one of the slots of the lens unit. Each temple and one of the snapping members are pivotable relative to the frame about a common pivot axis.

### BACKGROUND OF THE INVENTION

The present invention relates to a snap-fit type eyeglasses and, more particularly, to a pair of eyeglasses allowing easy assembly and detachment of a lens unit through easy operation.

A pair of eyeglasses generally includes a frame and two temples. Each temple is pivotably connected to one of two ends of the frame. The frame includes a groove receiving a lens unit between an inner wall and an outer wall of the insertion groove. The inner wall and the outer wall of the insertion groove serve as stops for preventing the lens unit from disengaging from the frame. However, the inner and outer walls of the insertion groove also hinder assembly of the lens unit. In assembly, the lens unit is forcibly inserted into the insertion groove while using the elasticity of the frame. However, the lens unit could break due to its fragility during assembly and detachment.

U.S. Pat. No. 8,430,506 discloses eyeglasses with snap-fitted lenses including an eyeglass frame and two lenses requiring two separate replacement operations, which is troublesome. A single lens is another option and is commonly used in sport goggles. Replacement of the lens in response to a change in the light is often required. For example, the lenses used under strong light are different from those used under weak light.

Thus, a need exists for novel eyeglasses allowing easy assembly and detachment of a lens unit in the form of a single lens.

### BRIEF SUMMARY OF THE INVENTION

Snap-fit type eyeglasses according to the present invention include a frame having an inner side and an outer side opposite to the inner side. The inner side of the frame is adapted to face a face of a wearer wearing the snap-fit type eyeglasses. The frame further includes a bottom edge extending between the inner side and the outer side. The bottom edge includes a groove having a downwardly facing opening. A stop is provided on each of two ends of the groove and extending toward a central portion of the frame between two ends of the frame. A temple is pivotably mounted to each end of the frame. A snapping member is pivotably mounted to each end of the frame and has a snapping hook on an end thereof. A lens unit includes two lenses integrally formed with each other as a single, monolithic piece. A neck is formed at a junction between the two lenses. A nose pad is mounted to the neck. The lens unit includes two ends each having a slot. The snapping hook of each snapping member is releasably engaged in one of the slots of the lens unit. Each temple and one of the snapping members are pivotable relative to the frame about a common pivot axis.

In an example, the snapping hook of each snapping member has a hook and extends through one of the slots of the lens unit. Each stop is sandwiched between the lens unit and the hook of one of the snapping members.

In another example, each temple includes a through-slot, and each snapping member includes a wedge releasably engaged in the through-slot of one of the temples. Each common pivot axis is located between the wedge and the snapping hook of one of the snapping members. The lens unit is sandwiched between the end of each snapping member and a corresponding stop.

The present invention will become clearer in light of the following detailed description of illustrative embodiments of this invention described in connection with the drawings.

### DESCRIPTION OF THE DRAWINGS

FIG. 1 shows a perspective view of snap-fit type eyeglasses according to the present invention.

FIG. 2 shows an exploded, perspective view of the snap-fit type eyeglasses according to the present invention.

FIG. 3 is a partial, perspective view of the snap-fit type eyeglasses of FIG. 1, with a portion of the snap-fit type eyeglasses cut away to show detailed structure.

FIG. 3A is an enlarged view of a circled portion of FIG. 3.

FIG. 4 is a view similar to FIG. 3A, illustrating snapping operation during assembly of the snap-fit type eyeglasses.

FIG. 5 is a view similar to FIG. 3A, illustrating another example of the snap-fit type eyeglasses according to the present invention.

### DETAILED DESCRIPTION OF THE INVENTION

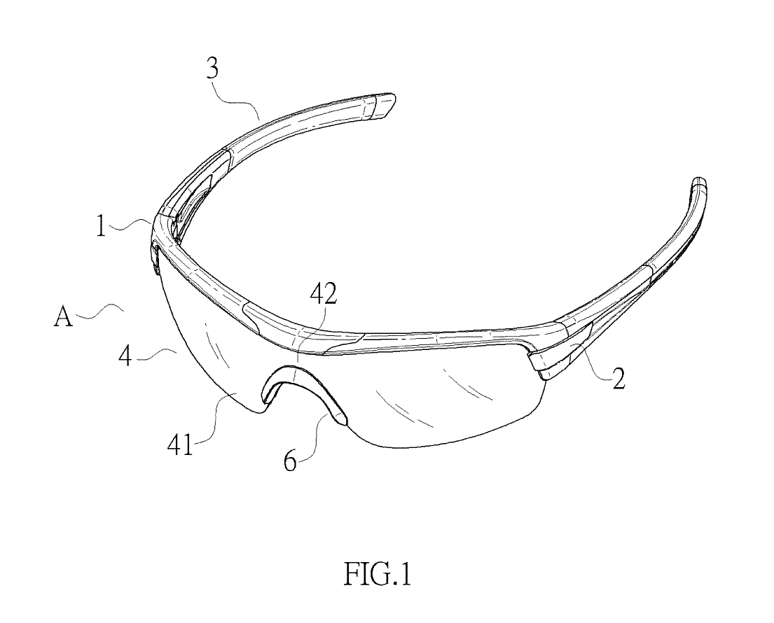

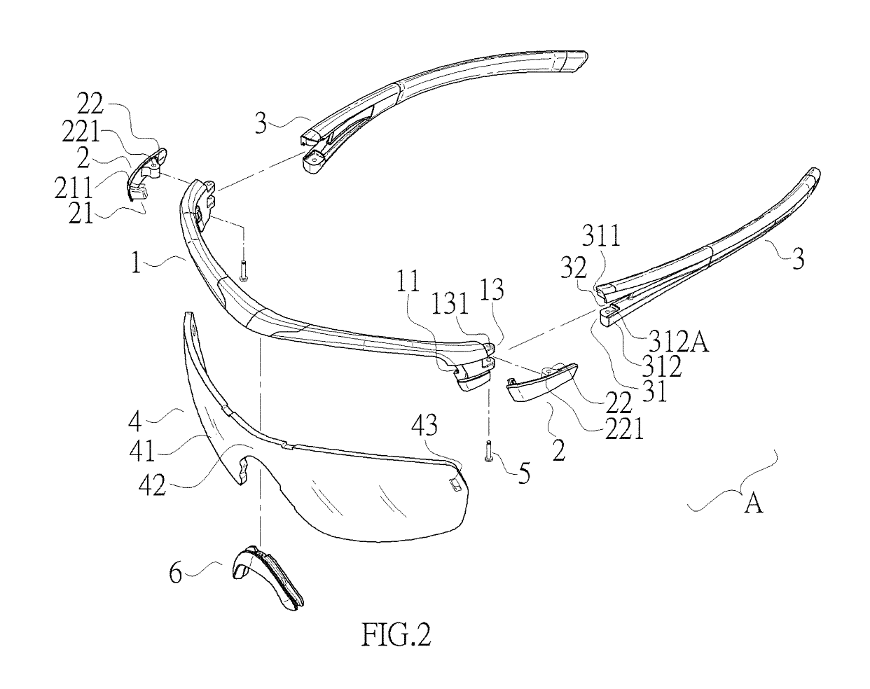

With reference to FIGS. 1 and 2, snap-fit type eyeglasses A according to the present invention include a frame 1 having an inner side and an outer side opposite to the inner side. The inner side of the frame 1 is adapted to face a face of a wearer wearing the snap-fit type eyeglasses A. The frame 1 further includes a bottom edge extending between the inner side and the outer side. The bottom edge includes a groove 12 having a downwardly facing opening. A stop 11 is provided on each of two ends of the groove 12 and extends toward a central portion of the frame 1 between the ends of the frame 1. A temple 3 is pivotably mounted to each end of the frame 1. A snapping member 2 is pivotably mounted to each end of the frame 1 and includes a snapping hook 21 on an end thereof, with the snapping hook 21 having a hook 211. Each temple 3 and one of the snapping members 2 are pivotable relative to the frame 1 about a common pivot axis.

The snap-fit type eyeglasses A further includes a lens unit 4 having two lenses 41 integrally formed with each other as a single, monolithic piece. A neck 42 is formed at a junction between the lenses 41 and has a bottom. A nose pad 6 has a top edge mounted to the bottom of the neck 42. A slot 43 is defined in each of two ends of the lens unit 4.

In assembly, a top edge of the lens unit 4 is inserted into the groove 12 of the frame 1 and abuts the stops 11. The snapping hook 21 of each snapping member 2 is releasably engaged in one of the slots 43 of the lens unit 4 with the hook 21 reliably engaged with a wall of the slot 43. The outer side of the lens unit 4 is free of engagement areas except the slots 43. The assembly is simple and easy. Disengagement of the lens unit 4 is prevented by the stops 11 and by the abutment between the lens unit 4 and the walls of the groove 12. In an alternative example, each slot 43 includes a notch such that each slot 43 has U-shaped cross sections.

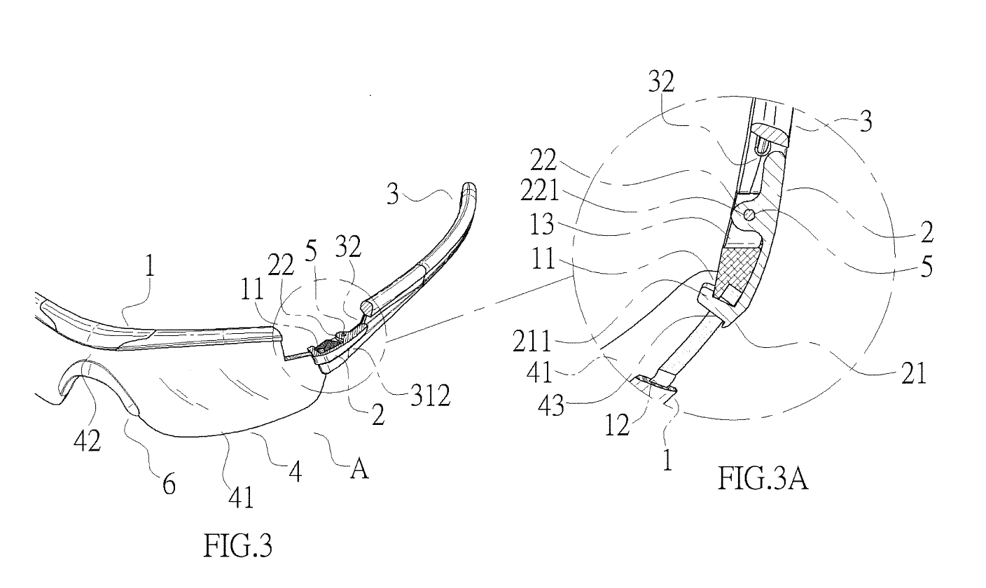

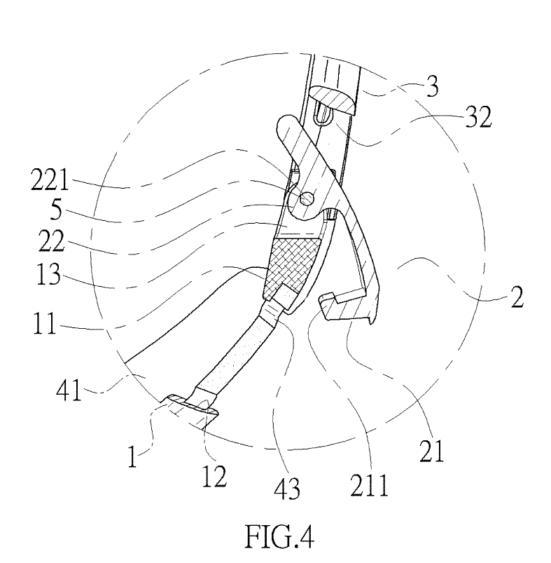

In the example shown in FIGS. 2, 3, 3A, and 4, the snapping hook 21 of each snapping member 2 extends through one of the slots 43 of the lens unit 4, and each stop 11 is sandwiched between the lens unit 4 and the hook 211 of one of the snapping members 2. During assembly, each snapping member 2 is pivoted inward from an outer side, and its hook 211 is inserted through one of the slots 43. After assembly, each snapping member 2 is at the outer side of a corresponding stop 11.

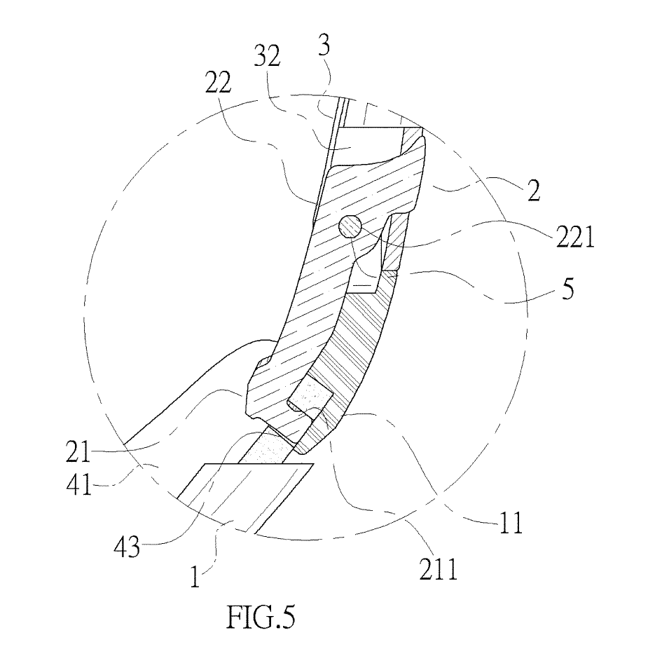

In another example shown in FIG. 5, each temple 3 includes a through-slot 34, and each snapping member 2 includes a wedge 24. Each common pivot axis is located between the wedge 24 and the snapping hook 21 of one of the snapping members 2. The wedge 24 is releasably engaged in the through-slot 34 of one of the temples 3. During assembly, each snapping member 2 is pivoted outward from an inner side, and its hook 211 is engaged in a corresponding slot 43. After assembly, each snapping member 2 is at the inner side of a corresponding stop 11. Thus, the lens unit 4 is sandwiched between the end of each snapping member 2 and a corresponding stop 11.

With reference to FIG. 2, the snap-fit type eyeglasses A further includes two pins 5. Each end of the frame 1 includes a lug 13 having a through-hole 131. Each snapping member 2 includes an ear 22 having a through-hole 221. Each pin 5 extends through the through-hole 131 of the lug 13 of one of the ends of the frame 1 and the through-hole 221 of the ear 22 of one of the snapping members 2. Each temple 3 includes a forked end 31 having an upper leg 311 and a lower leg 312. Each of the upper and lower legs 311 and 312 has a pin hole 312A. Each pin 5 extends through the pin holes 312A of one of the temples 3. Each pin 5 defines one of the common pivot axes. Furthermore, the upper and lower legs 311 and 312 of each temple 3 define a receiving groove 32 facing one of the ends of the frame 1. The receiving groove 32 of each temple 3 provides room for pivotal movement of one of the snapping members 2. Since each temple 3 and the corresponding snapping member 2 pivot about a common pivot axis and share the same pin 5, the resultant structure of the snap-fit eyeglasses A is simple.

The snapping hook 21 of each snapping member 2 has a first spacing to a corresponding common pivot axis. Each slot 43 has a second spacing to a corresponding common pivot axis. The first spacing is slightly smaller than the second spacing. Thus, the snapping hook 21 of each snapping member 2 can be forcibly extended into one of the slots 43 by elastic deformation of the snapping member 2, providing tight coupling.

By simple pivotal movement of the snapping members 2 into the slots 43 of the lens unit 4 and by using the snapping members 2 as guarding members for the lens unit 4, the lens unit 4 can be easily assembled to the frame 1. On the other hand, the lens unit 4 can be easily detached by pivotal movement of the snapping members 2 in the reverse direction. Thus, the lens unit 4 can be easily, conveniently, and safely detached for maintenance purposes while allowing replacement of the lens unit 4 in response to a change in the light. For example, since the lenses used under strong light are different from those used under weak light, the lens unit 4 can be rapidly changed if the light becomes strong or weak.

Although specific embodiments have been illustrated and described, numerous modifications and variations are still possible without departing from the scope of the invention. The scope of the invention is limited by the accompanying claims.

1. Snap-fit type eyeglasses comprising:
a frame including two ends, with the frame further including an inner side and an outer side opposite to the inner side, with the inner side of the frame adapted to face a face of a wearer wearing the snap-fit type eyeglasses, with the frame further including a bottom edge extending between the inner side and the outer side, with the bottom edge including a groove having a downwardly facing opening, with a stop provided on each of two ends of the groove and extending toward a central portion of the frame between the two ends of the frame;
a temple pivotably mounted to each of the two ends of the frame;
a snapping member pivotably mounted to each of the two ends of the frame, with each snapping member including a snapping hook on an end thereof; and
a lens unit, with the lens unit including two lenses integrally formed with each other as a single, monolithic piece, with a neck formed at a junction between the two lenses, with a nose pad mounted to the neck, with the lens unit including two ends, with each of the two ends of the lens unit including a slot,
with the snapping hook of each snapping member releasably engaged in one of the slots of the lens unit, with each temple and one of the snapping members pivotable relative to the frame about a common pivot axis.

2. The snap-fit type eyeglasses as claimed in claim 1, with the snapping hook of each snapping member having a hook and extending through one of the slots of the lens unit, with each stop sandwiched between the lens unit and the hook of one of the snapping members.

3. The snap-fit type eyeglasses as claimed in claim 1, with each temple including a through-slot, with each snapping member including a wedge releasably engaged in the through-slot of one of the temples, with each common pivot axis located between the wedge and the snapping hook of one of the snapping members, with the lens unit sandwiched between the end of each snapping member and a corresponding one of the stops.

4. The snap-fit type eyeglasses as claimed in claim 1, further comprising: two pins, with each of the two ends of the frame including a lug having a through-hole, with each snapping member including an ear having a through-hole, with each of the two pins extending through the through-hole of the lug of one of the two ends of the frame and the through-hole of the ear of one of the snapping members, with each temple including a forked end having an upper leg and a lower leg, with each of the upper and lower legs having a pin hole, with each of the two pins extending through the pin holes of one of the temples, with each of the two pins defining one of the common pivot axes.

5. The snap-fit type eyeglasses as claimed in claim 4, with the upper and lower legs of each temple defining a receiving groove facing one of the two ends of the frame, with the receiving groove of each temple providing room for pivotal movement of one of the snapping members.

6. The snap-fit type eyeglasses as claimed in claim 1, with the snapping hook of each snapping member having a first spacing to a corresponding one of the common pivot axes, with each slot having a second spacing to a corresponding one of the common pivot axes, with the first spacing slightly smaller than the second spacing, with the snapping hook of each snapping member forcibly extended into one of the slots by elastic deformation of the snapping member, providing tight coupling.
